(19) United States
(12) Patent Application Publication
(10) Pub. No.: US 2002/0013805 A1
(43) Pub. Date: Jan. 31, 2002

(54) LogNet: a low cost, high reliability network for embedded systems

(76) Inventor: Valeri Popescu, Rancho Santa Fe, CA (US)

Correspondence Address: Valeri Popescu, PO Box 569, Rancho Santa Fe, CA, 92067-0569, US

(21) Appl. No.: 09/727,379

(22) Filed: Mar. 21, 2001

Related U.S. Application Data
(60) Provisional application No. 60/168,158, filed on Nov. 30, 1999.

(51) Int. Cl. G06F 15/16

(52) U.S. Cl. 709/201

(57) ABSTRACT

A low cost network efficiently supporting both event-driven and constant data rate messages is implemented using inexpensive off-the-shelf micro controllers and firmware. The network firmware uses less than 2K bytes for the network hub and less than 1K bytes for the other network nodes A combination of polling and token passing ensures each node can become “Master” and control the network and thus providing for steady data rate transfers. A specially designated “Hub-node” ensures fairness by preventing idling nodes from unnecessarily taking control of the network access. The Hub controls the token advance signal going to all nodes. The client/server protocol with peer/peer capabilities utilizes both master/slave and token passing media access methods.

A network is a group of two or more computers or network nodes linked together and enabling communications between them. To communicate with one another, the interconnected network nodes must follow rules governing the transmission, reception, and interpretation of data. The rules defining how messages are communicated on a network along with electrical and physical definitions are called network protocols.

The Open System Interconnection (OSI) is an ISO standard that defines a networking framework for implementing protocols in seven layers of functionality. Most embedded systems' network protocols do not require all the functionality the OSI reference model provides, nor can it be burdened with the corresponding overhead, but instead it has been optimized into simpler subsets. LogNet uses three layers defined from highest level to lowest level as: application, data link, and physical. The application layer provides an interface for program-to-program communication between network nodes. The data link layer is responsible for establishing and maintaining reliable communications channels and physically routing data from one node to another. The physical layer manages putting data onto and taking data off the physical network media.

Embedded real-time networks require high efficiency, deterministic latency, robustness, and low cost per node. In the following sections, each of the network layers are described while concentrating on the data link layer detailing how the protocol actually works along with details of how the requirements of an embedded network are met including some unique properties of LogNet. The network's initial implementation and racecar application are discussed.

### Physical Layer

The physical layer can be implemented using the Telecommunications Industry Association Electronic Industries Alliance TIA/EIA485-A standard. Due to its low-cost, simplicity and robustness, the RS-485 has become widely used in many industrial applications. RS-485's use of differential transmission and simple inexpensive, twisted pair wiring makes it very robust even in noisy industrial and automotive environments. Inexpensive RS-485 transceivers are widely available; some such as MAXM's MAX485 offer extremely high Electrostatic Discharge (ESD) protection.

RS-485 is a half-duplex multidrop physical layer interface allowing multiple transmitters and receivers to reside on the same line. The standard only defines the characteristics of the line drivers and receivers. As only one transmitter may be active at a time, higher levels of the network protocol are necessary to determine how and when a node may transmit.

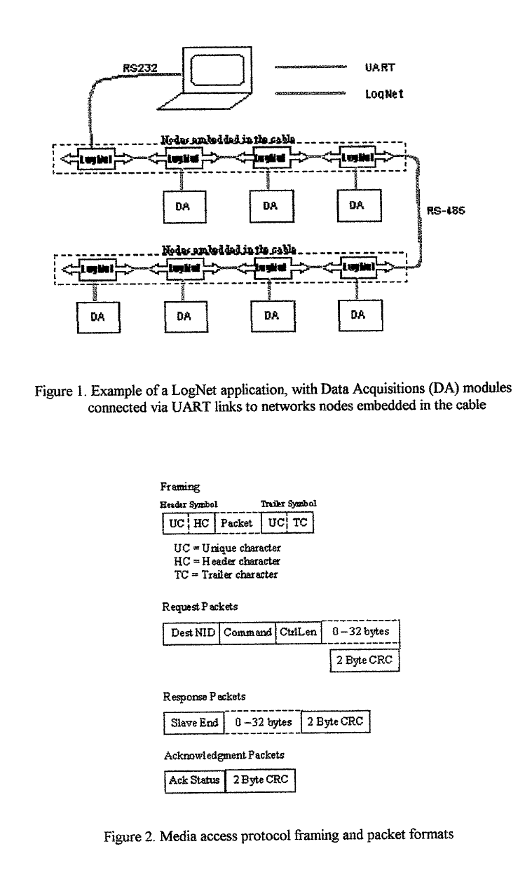

The LogNet physical layer consists of two RS-485 electrically compliant twisted pair signals: Data and TokenClk. In its current implementation, the network nodes are implemented in an inexpensive microcontroller embedded in the network cable. While Data must be connected to each network node, TokenClk need only be connected to nodes wishing to initiate network transactions. The data link layer protocol defines how these signal are used. In the example shown in FIG. 1., each node has a RS-485 port and an UART (point to point) link to the companion embedded module. One of the nodes is a gateway to a central computer. Other physical layers such as fiber optics and wireless can be used.

### Data Link Layer

The basic concept is one of a virtual bus utilizing a master/slave methodology with some overhead for reliability. All network nodes have unique Network Identifiers (NIDs) assigned during initialization allowing for addressing of individual nodes. The network utilizes a Hub, which serves as the primary master, and arbitrator allowing for multilevel prioritized network access. Data is transferred through network transactions initiated by the current master and executed by the addressed slave either by responding with data or acknowledging data transfer. Data transfers with a complete acknowledgement from the node receiving data. In the special case of a broadcast where all nodes are addressed, the network hub provides the acknowledgement.

The utilization of a Hub simplifies the network protocol and allows the other network nodes to be physically implemented with very inexpensive micro-controllers short on both data memory and program space. The Hub also allows for simplified central diagnostics.

A network transaction is a sequence of one or more discrete framed packets each of which is a string of characters. These packets are framed by being delimited with symbols and special two character sequences to define the beginning and end of each packet. The characters consist of eight data bits and are transmitted serially over the physical network media individually contained within a sub-frame. Each packet contains Cyclic Redundancy Check (CRC) data to detect corrupted transmissions. Message overhead has been reduced as much as possible without sacrificing a high level of reliability either in error detection or packet delineation.

Serial Data is transferred asynchronously on the Data signal in a sub-frame utilizing a standard UART format synchronized with start and stop bits. The sub-frame transmitted consists of 10 bits with one start bit, eight bits of data, and one stop bit. All nodes are set to the same bit rate. While most micro-controllers implement the UART in hardware, this sublayer of the protocol can be easily implemented in firmware (at reduced speed) for the most cost sensitive applications.

The TokenClk signal is generated by the hub and read by the other network nodes. This signal is used to synchronize “token” passing in the network's multi-master mode. Additionally, TokenClk can be used by the Hub to force a current master to relinquish its master state enforcing network access prioritization and determinacy. As TokenClk is a relatively slow signal compared to the Data signal, which only conveys information on a rising edge, debouncing techniques are used to guarantee the signal transmission is extremely reliable.

Packets are divided into fields defining command opcode, the NID of destination node, control bits, and the message payload carried for the application layer followed by a two byte CRC. Further, these packets are delimited by one (or two) byte symbols beginning with a packet header and ending with a packet trailer. Request, response, and acknowledgement packet headers and traders utilize unique symbols. In all cases, the first byte is 0xXX (hex) followed by a second byte defining the packet type and whether the symbol is a head or tail. Whenever 0xXX occurs in any other field the sequence 0XXXX is used to indicate the single character 0xXX.

### Packet Definitions

The three different packet types are request, response, and acknowledgement. Request packets are used to initiate a network transaction and may contain network data as part of the data link layer protocol, or an application message in the case of a write request, or the information necessary to a read operation. Response packets carry application messages or network data from a slave to the current master. Acknowledgement packets are transmitted by the data recipient to complete the transaction reliably. FIG. 2 shows the packet formats.

Network addresses or NIDs consist of an 8-bit byte allowing addressing of up to 255. Request packets start with a destination NID byte then a Command byte followed by a CtrlLen byte. The Command byte specifies the operation to be performed while the CtrlLen byte utilizes two fields specifying both control information and the number of bytes to be read or written. Zero to 32 data bytes follow ending in a two byte CRC. Longer application messages require multiple transactions. Response packets start with a Slave End byte that utilizes two fields specifying the status of the transaction and the number of bytes read. Slave End is followed by zero to 32 bytes of data ending in a two byte CRC. The Slave End byte may also indicate that the request packet was corrupted.

SlaveEnd also provides status, which may include a request to the current master to initiate another transfer with four levels of priority; low, medium, high, or urgent. This status mechanism allows a slave that needs to transfer additional data to secure the network for a longer period of time. The hub may also use this information to temporarily raise the network access priority of the current master.

Acknowledgement packets contain only an AckStatus byte and a two byte CRC. This packet is issued to complete a transaction or to indicate the previous write request or read response was corrupted. The following table contains the list of commands for request packets:

| Commands | Description | |
|---|---|---|
| WriteNID | Assign a NID to a node, addressed by | Manufacture ID |
| ReadNID | Read the NID of a node, addressed by | Manufacture ID |
| Read | Read 1 to 32 bytes | |
| Write | Write 1 to 32 bytes | |
| ReadP | Read 1 to 32 bytes, allow partial reads | |
| WriteP | Write 1 to 32 bytes, allow partial writes | |
| SetTokenID | Set the system in “Token” mode and | the current Token |
| | | ID |
| CancelToken | Cancel “Token” mode | |
| Sync | Synchronize a node [soft reset] | |
| Quiet | Suspend a note's activity (Stand by) | |
| WakeUp | Resume the note's activity | |

### Network Transactions

Data is transferred by completing network transactions. All network transactions are initiated by the current master with a request packet. In the case of a read command, the addressed slave replies with a response packet. After the master successfully receives the read response, it issues an acknowledgement packet. In the case of a write, the addressed slave replies with an acknowledgement packet. Most commands defined above, but not explicitly labeled as read or write, are write requests transmitting network data. The addressed slave acknowledges them. Should any packet become corrupted or otherwise lost in transmission, the entire transaction is restarted.

The protocol guarantees delivery of exactly one copy of each application message or network data in the order they are transmitted. As a corrupted acknowledgement could result in retransmission of the original packet, duplication is avoided through the use of a duplicate transmission bit in the command byte.

### Media-access Control

The two modes used by the LogNet protocol to control media access are polling and token passing. They assume one of the nodes is declared “Master” while the rest are relegated to “Slave” status.

The network initialization firmware running in the Hub is provided with a configuration file containing the unique Manufacturer ID of each of the nodes in the. From this information, the Hub assigns consecutive NIDs to each node in the system. The application in the Hub can also set the network access priority of each node. After initializing the network, the Hub becomes its first master.

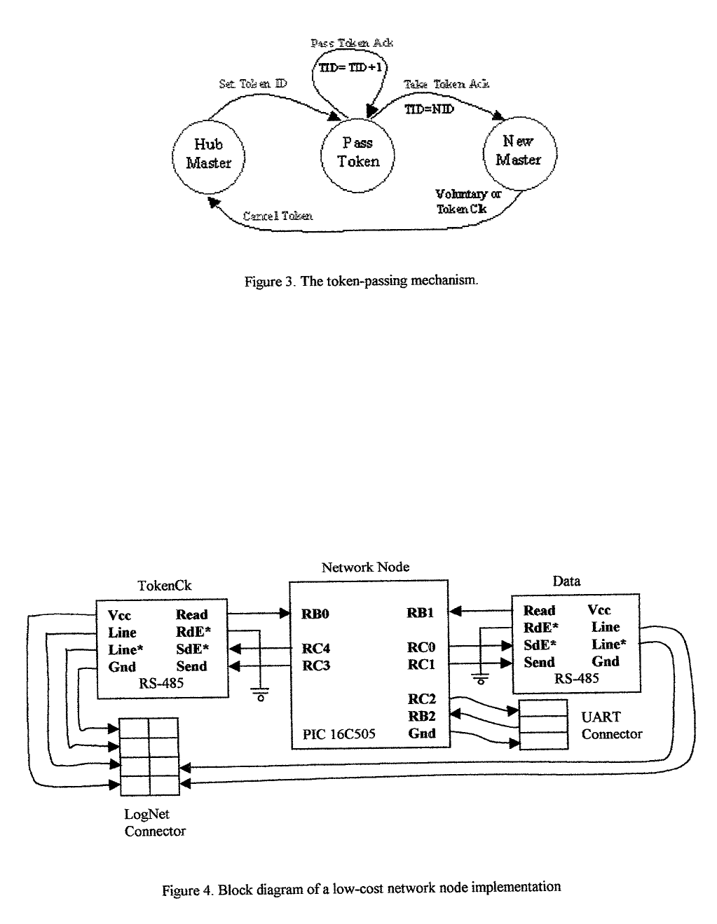

The token passing mode allows for multiple masters. The Hub is responsible for managing the token passing protocol. FIG. 3 shows the protocol's main states. The Hub sets the network in the “Token passing,” mode by broadcasting a packet to all nodes to set the current Token ID. This mode is maintained until mastership of the network is accepted by one of the network nodes taking the token. While in the Token Passing mode, the Hub generates the TokenClk signal. Each time a rising clock edge is received by the network nodes, they increment an internal “token ID” counter. When the token ID counter equals the NID of the node, the node can either accept the token and assume control of the network by issuing a TakeToken packet or pass the token by issuing the PassToken packet.

When a node takes the token and becomes the new master, it initiates network transactions as in the polling mode until it either voluntarily relinquishes or the Hub forces it to relinquish its master state. The Hub can activate the TokenClk line causing the TID to increment and thus be different than the node's NID. This alerts the master that his time is up and to pass the token back to the Hub with a CancelToken packet. The Hub then re-starts the token passing mode using the SetTokenID packet and activates the TokenClk signal to allow the token to be passed to the next possible network master (within the priority scheme).

The hub implements additional error handling procedures to deal with lost or duplicated tokens. This can be the case when a node fails to pass a token or token passing packets are corrupted.

### Ensuring fairness

Ensuring fairness in accessing the network is the goal of most protocols. LogNet provides the token passing mechanism to give each node a chance to become Master. Fairness also assumes the Master will surrender its position to give the chance to another node. The Hub can also enforce a “time slicing” policy by asking the current Master to surrender its position at the end of the transaction in progress if it held the position longer than the pre-set time slice.

### Physical Implementation

The schematics below show the implementation of a node using a Microchip PIC microprocessor. For an increased network bandwidth, a 20 Mhz external crystal can be connected between RB4 and RB5 pins. To reduce the power requirements, the chip “Sleep” mode is activated each time the node surrenders its Master position (the chip is “awakened” by a change on an input pin). The power consumption in stand-by mode is less than five uW, and in operation is less than 10 mW (at 5V). The power can be supplied by the companion embedded module or by the network cable.

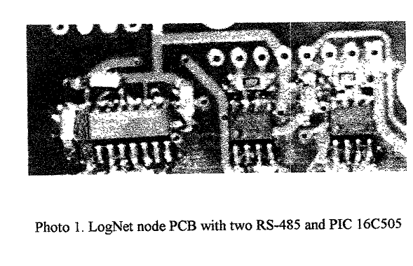

Port B is used for reading in all three data lines: TokenClk Read (RB0), Network Data Read (RB1), and serial link RXd (RB2). Port C is used for output: Network Data Send (RC1), serial link TXd (RC2), Network Data Send Enable (RC0). In addition the Master drives the Token Clock: TokenClk Send (RC3) and TokenClk Send Enable (RC4) The serial link is implemented as UART (this example) or SSP (FIG. 4 and Photo 1).

The interface node firmware utilizes less than 2k instructions. There are less than 60 8-bit registers used by the firmware. The hub utilizes close to 2k instructions. The data transfer rate is largely determined by the speed at which the RS-485 can operate and the clock speed of the micro-controller implementing the node. Peak data rates of up to four MBits per second can be reached.

I claim:

1. A process of transferring digital data between several data processing nodes (Nodes) over common data link to enable said Nodes to gain access to the data link when permitted by a Master Node assigned the role of managing the data transfer time slots available on the common data link.

2. A process of transferring digital data between several data processing nodes (Nodes) over a common data link that provides a mechanism by which each Node can assume the role of Master Node in order to give the said node temporary control over the common data link in order for the said Node to transfer data between itself and other nodes of its choice. The process by which a said Node obtains the Master Node status requires only two signals:
(a) data signal
(b) token signal
The token signal is generated by the Master Node and is received by all the other Nodes. Each Node maintains a Token Count that is incremented each time the said Node receives a token signal and is compared with the Node internal identifier that is unique to each node. When a Node detects that the Token Count equals its internal identifier, the said Node can assume the Master Node status.

3. A process of transferring digital data between several data processing nodes (Nodes) over a common data link to limit the amount of time a Node maintains the Master Node status to ensure fairness in sharing the common data link by several Nodes and to prevent any given Node from monopolizing the common data link and thus preventing other Nodes from utilizing the common data link for their own needs.
